(19) United States
(12) Patent Application Publication
(10) Pub. No.: US 2024/0300422 A1
(43) Pub. Date: Sep. 12, 2024

(54) MOUNTING MEMBER, MOUNTING UNIT, CABLE ROUTING MODULE, AND CABLE ROUTING MEMBER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Takuya OISHI, Osaka (JP)

(21) Appl. No.: 18/290,256

(22) PCT Filed: Mar. 29, 2022
(86) PCT No.: PCT/JP2022/015333

§ 371 Date: Nov. 10, 2023

(30) Foreign Application Priority Data
May 21, 2021 (JP) 2021-085918

(51) Int. Cl. B60R 16/02; H02G 3/00; H02G 3/32

(52) U.S. Cl. CPC B60R 16/0215; H02G 3/263; H02G 3/32

(57) ABSTRACT

A mounting member according to an embodiment of this disclosure is to be mounted on a sheet having a first main face and a second main face provided on the back side of the first main face, and a wire member is to be fixed to the mounting member. The mounting member includes: a leading end penetrating portion that is located on the first main face side and is capable of penetrating a portion of the sheet from the second main face side to the first main face side; a fixing portion that is located on the second main face side and to which the wire member is to be fixed; and a clip portion that connects the leading end penetrating portion and the fixing portion to each other, and holds the sheet in a thickness direction.

### TECHNICAL FIELD

The present disclosure relates to a mounting member, a mounting unit, a cable routing module, and a cable routing member.

### BACKGROUND

A structure for fixing a mounting member to a sheet using an adhesive and fixing harness components to the mounting member is disclosed as a conventional structure for fixing harness components such as wires and connectors to a sheet for a roof lining or the like provided in a vehicle, for example (e.g., see Patent Document 1). With such a structure, wires can be routed with respect to the sheet such that the positions of the wires, which are harness components, do not shift from the preset positions, for example.

### PRIOR ART DOCUMENT

### Patent Document

Patent Document 1: JP 2000-335329 A

### SUMMARY OF THE INVENTION

### Problems to be Solved

However, with the above structure, for example, a portion where the mounting member and the sheet are adhered may peel off due to vibration or the like while a vehicle is traveling, and the mounting member may come off from the sheet.

The present disclosure was made to resolve the above issues, and aims to provide a mounting member, a mounting unit, a cable routing module, and a cable routing member that can prevent the mounting member from coming off from a sheet.

### Means to Solve the Problem

A mounting member according to this disclosure is a mounting member that is to be mounted on a sheet having a first main face and a second main face provided on the back side of the first main face, and to which a harness component is to be fixed, the mounting member including: a leading end penetrating portion that is located on the first main face side and is capable of penetrating a portion of the sheet from the second main face side to the first main face side; a fixing portion that is located on the second main face side and to which the harness component is to be fixed; and a holding portion that connects the leading end penetrating portion and the fixing portion to each other, and holds the sheet in a thickness direction.

A mounting unit according to this disclosure includes: the mounting member; and a fixing member that is fixed to the harness component and fitted to the fixing portion.

A cable routing module according to this disclosure includes: the mounting unit; the harness component to which the fixing member is fixed; and the sheet on which the mounting member is mounted.

A cable routing member according to this disclosure includes: the mounting member; and the sheet on which the mounting member is mounted.

### Effect of the Invention

The mounting member, the mounting unit, the cable routing module, and the cable routing member according to this disclosure can prevent the mounting member from coming off from the sheet.

### BRIEF DESCRIPTION OF THE DRAWINGS

FIG. 1 is a perspective view of a portion of a cable routing module according to one embodiment.

FIG. 2 is a front view of a portion of the cable routing module according to one embodiment.

FIG. 3 is an exploded front view of a portion of the cable routing module according to one embodiment.

FIG. 4 is a cross-sectional view of a portion of a cable routing member according to one embodiment.

FIG. 5 is a front view of a mounting member according to one embodiment.

FIG. 6 is a side view of the mounting member according to one embodiment.

FIG. 7 is a front view of a mounting member in another example.

FIG. 8 is a front view of a mounting member in another example.

FIG. 9 is a front view of a mounting member in another example.

FIG. 10 is a front view of a mounting member in another example.

FIG. 11 is a cross-sectional view of a portion of a cable routing member in another example.

FIG. 12 is a cross-sectional view of a portion of a cable routing member in another example.

FIG. 13 is a front view of a mounting member in another example.

### DETAILED DESCRIPTION TO EXECUTE THE INVENTION

### Description of Embodiments of the Present Disclosure

First, embodiments of this disclosure will be listed and described below.

[1] A mounting member according to this disclosure is a mounting member that is to be mounted on a sheet having a first main face and a second main face provided on the back side of the first main face, and to which a harness component is to be fixed, the mounting member including: a leading end penetrating portion that is located on the first main face side and is capable of penetrating a portion of the sheet from the second main face side to the first main face side; a fixing portion that is located on the second main face side and to which the harness component is to be fixed; and a holding portion that connects the leading end penetrating portion and the fixing portion to each other, and holds the sheet in a thickness direction.

With this configuration, the holding portion that holds the sheet in the thickness direction can prevent the mounting member from coming off from the sheet. Further, because the leading end penetrating portion capable of penetrating a portion of the sheet from the second main face side to the first main face side eliminates the need to provide a mounting hole in the sheet in advance, and the mounting member can be mounted on the portion of the sheet.

[2] It is preferable that the holding portion is a clip portion constituted of a wire member and having an oval shape overall when viewed in a first direction orthogonal to the sheet.

With this configuration, the holding portion is a clip portion constituted of a wire member and having an oval shape overall, and thus can favorably hold the sheet with a simple structure.

[3] It is preferable that the fixing portion is located at a center in a longitudinal direction of the clip portion.

With this configuration, the fixing portion is supported by the clip portion in a well-balanced manner, compared to a case where the fixing portion is arranged at a position shifted from the center in the longitudinal direction of the clip portion, for example.

[4] It is preferable that the fixing portion is located at a center in a lateral direction of the clip portion.

With this configuration, the fixing portion is supported by the clip portion in a well-balanced manner, compared to a case where the fixing portion is arranged at a position shifted from the center in the lateral direction of the clip portion, for example.

[5] It is preferable that the clip portion includes a first constituent part located on the first main face side, a second constituent part located on the second main face side, and an intermediate connection part that connects the first constituent part and the second constituent part to each other and is located to pass through the sheet, the first constituent part includes a pair of first parallel longitudinally extending parts and a first connection part that connects the first longitudinally extending parts to each other, the second constituent part includes a pair of second parallel longitudinally extending parts and a second connection part that connects the second longitudinally extending parts to each other, and the length, from the first connection part, of one of the first longitudinally extending parts that is continuous with the leading end penetrating portion is set such that the one first longitudinally extending part extends beyond the center in the longitudinal direction of the clip portion.

With this configuration, the clip portion can hold the sheet in a longer range and more strongly hold the sheet, compared to a case where the length, from the first connection part, of one of the first longitudinally extending parts that is continuous with the leading end penetrating portion is set to the length to the center in the longitudinal direction of the clip portion, for example.

[6] It is preferable that the clip portion includes a first constituent part located on the first main face side, a second constituent part located on the second main face side, and an intermediate connection part that connects the first constituent part and the second constituent part to each other and is located to pass through the sheet, the first constituent part includes a pair of first parallel longitudinally extending parts and a first connection part that connects the first longitudinally extending parts to each other, the second constituent part includes a pair of second parallel longitudinally extending parts and a second connection part that connects the second longitudinally extending parts to each other, and the length, from the second connection part, of one of the second longitudinally extending parts that is continuous with the fixing portion is set such that the one second longitudinally extending part extends beyond the center in the longitudinal direction of the clip portion.

With this configuration, the clip portion can hold the sheet in a longer range and more strongly hold the sheet, compared to a case where the length, from the second connection part, of one of the second longitudinally extending parts that is continuous with the fixing portion is set to the length to the center in the longitudinal direction of the clip portion, for example.

[7] It is preferable that the leading end penetrating portion extends in the first direction.

With this configuration, it is possible to easily perform operation of passing the leading end penetrating portion through the sheet from the second main face side to the first main face side.

[8] It is preferable that the leading end penetrating portion extends along the first main face.

With this configuration, the leading end penetrating portion does not protrude greatly from the first main face, and there is no need to provide a large mounting space on the first main face side. That is, this configuration can also handle a case where there is not much depth on the first main face side.

[9] It is preferable that the mounting member includes a coming-off preventing portion that prevents the holding portion from coming off from the first main face side to the second main face side through engagement with the sheet.

With this configuration, the coming-off preventing portion prevents the holding portion from coming off from the first main face side to the second main face side. Therefore, it is possible to prevent a harness component from coming off from a sheet together with a mounting member.

[10] It is preferable that the mounting member includes a rotation prevention portion that prevents rotation of the holding portion with respect to the sheet through engagement with the sheet.

With this configuration, the rotation prevention portion prevents the holding portion from rotating with respect to the sheet. Therefore, it is possible to prevent a harness component from rotating with respect to the sheet together with the mounting member.

[11] It is preferable that the rotation prevention portion includes a rotation prevention penetrating portion capable of penetrating a portion of the sheet from the second main face side to the first main face side, a biasing portion that biases the rotation prevention penetrating portion in a direction away from the second main face, and a maintaining portion that maintains a state in which the rotation prevention penetrating portion penetrates the sheet against a biasing force of the biasing portion.

With this configuration, separation of the rotation prevention penetrating portion from the second main face due to the action of the biasing portion avoids the restriction of movement of the holding portion as a result of the rotation prevention penetrating portion penetrating the sheet when the holding portion is arranged on the sheet. Thus, the maintaining portion maintains the state in which the rotation prevention penetrating portion penetrates the sheet. Therefore, rotation of the holding portion with respect to the sheet is prevented by two portions, namely, the rotation prevention penetrating portion and a portion passing through the through-hole of the sheet formed by the leading end penetrating portion.

[12] It is preferable that the holding portion and the fixing portion are made of a metal.

With this configuration, the holding portion and the fixing portion are made of a metal, and thus separately shaped portions can be easily joined together, for example. Thus, the mounting member can be easily produced.

[13] A mounting unit according to this disclosure includes the mounting member; and a fixing member that is fixed to the harness component and fitted to the fixing portion.

With this configuration, as a result of fixing the fixing member to the harness component and fitting the fixing member to the fixing portion, the harness component can be easily mounted on the mounting member.

[14] It is preferable that the fixing portion has a fixing hole, the harness component is a wire member, and the fixing member has a wire fixing portion that is fixed to the wire member and a fitting portion that protrudes from the wire fixing portion, passes through the fixing hole, and is fitted to the fixing portion.

With this configuration, the wire member can be easily mounted on the mounting member.

[15] The cable routing module according to this disclosure includes the mounting unit; the harness component to which the fixing member is fixed; and the sheet on which the mounting member is mounted.

With this configuration, functional effects similar to those of the mounting member can be obtained.

[16] A cable routing member according to this disclosure includes the mounting member; and the sheet on which the mounting member is mounted.

With this configuration, functional effects similar to those of the mounting member can be obtained.

### DETAILS OF EMBODIMENTS OF THE PRESENT DISCLOSURE

A specific example of a cable routing module 10 according to this disclosure will be described below with reference to the drawings. Portions of configurations may be exaggerated or simplified in the diagrams for convenience in the description. In addition, the ratios between the dimensions shown in the diagrams may be different from each other. Being “parallel” or “orthogonal” as used herein includes not only being strictly parallel or orthogonal, but also being generally parallel or orthogonal, as long as the actions and effects of this embodiment can be achieved. Note that the present invention is not limited to these examples, and is defined by the claims, and all changes that come within the meaning and range of equivalency of the claims are intended to be embraced therein.

### [Configuration of Cable Routing Module 10]

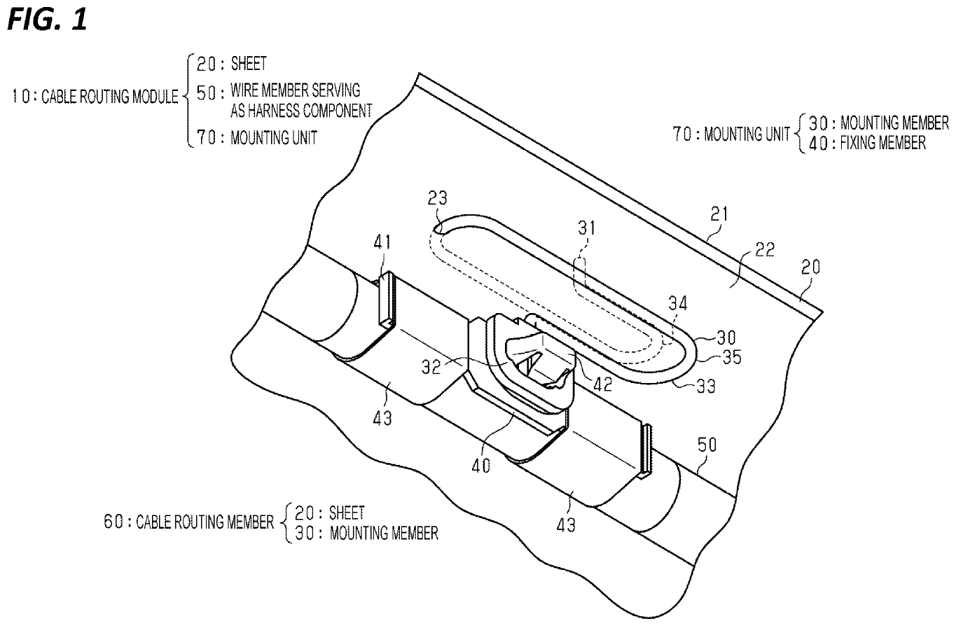

As shown in FIGS. 1 to 3, the cable routing module 10 includes a sheet 20, a mounting member 30, a fixing member 40, and a wire member 50 serving as a harness component. Note that the sheet 20 and the mounting member 30 constitute a cable routing member 60 in this embodiment. Also, the mounting member 30 and the fixing member 40 constitute a mounting unit 70.

### [Configuration of Sheet 20]

The sheet 20 is a roof lining provided on an inner surface of the ceiling of a vehicle body, for example. The sheet 20 of this embodiment is a nonwoven fabric. The sheet 20 includes a first main face 21 and a second main face 22 provided on the back side of the first main face 21.

### [Configuration of Mounting Member 30]

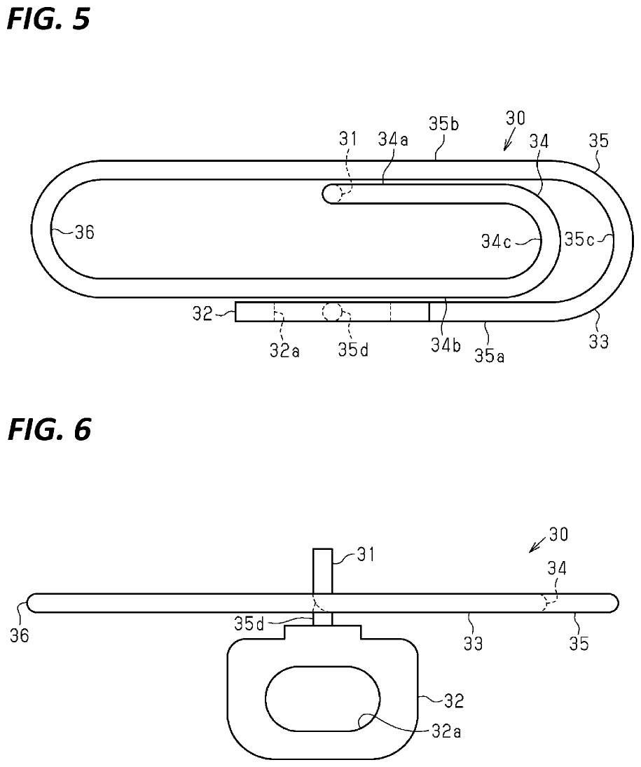

As shown in FIGS. 1 to 6, the mounting member 30 includes a leading end penetrating portion 31, a fixing portion 32, and a clip portion 33 serving as a holding portion. Note that FIGS. 5 and 6 show the mounting member 30 alone, which is not mounted on the sheet 20.

The leading end penetrating portion 31 is made of a metal. The leading end penetrating portion 31 and the clip portion 33 are constituted of a continuous wire member made of a metal. The leading end penetrating portion 31 is an end portion of the metal wire member. The length of the leading end penetrating portion 31 is set to longer than the thickness of the sheet 20.

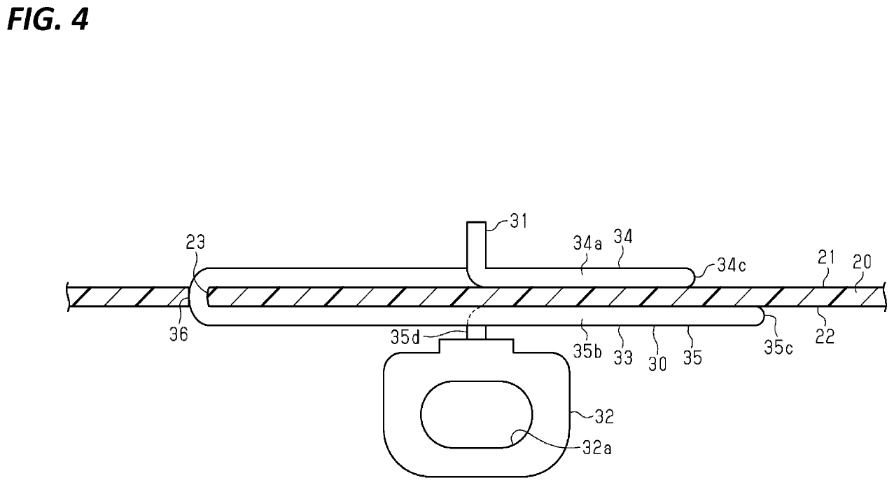

As shown in FIG. 4, the leading end penetrating portion 31 is arranged on the first main face 21 side. The leading end penetrating portion 31 is capable of penetrating a portion of the sheet 20 from the second main face 22 side to the first main face 21 side. That is, the leading end penetrating portion 31 is formed to be capable of coming through the portion of the sheet 20 provided with no hole, and penetrating the portion of the sheet 20 from the second main face 22 side to the first main face 21 side. The sheet 20 has a through-hole 23 provided as a result of the leading end penetrating portion 31 coming through the sheet 20 in the state in which the mounting member 30 is mounted.

The fixing portion 32 is made of a metal. The fixing portion 32 is plate shaped.

The fixing portion 32 is arranged on the second main face 22 side. The fixing portion 32 has a fixing hole 32a.

The clip portion 33 connects the leading end penetrating portion 31 and the fixing portion 32 to each other, and holds the sheet 20 in the thickness direction thereof.

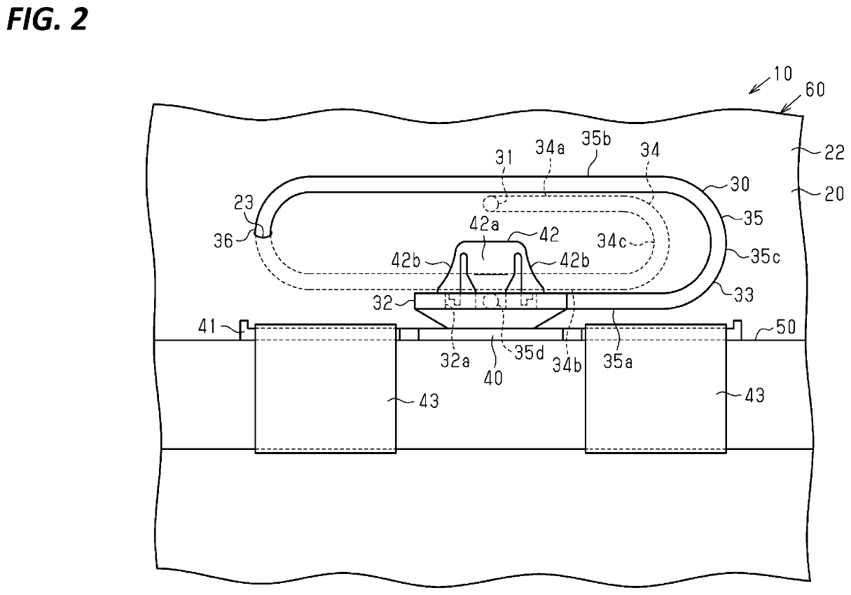

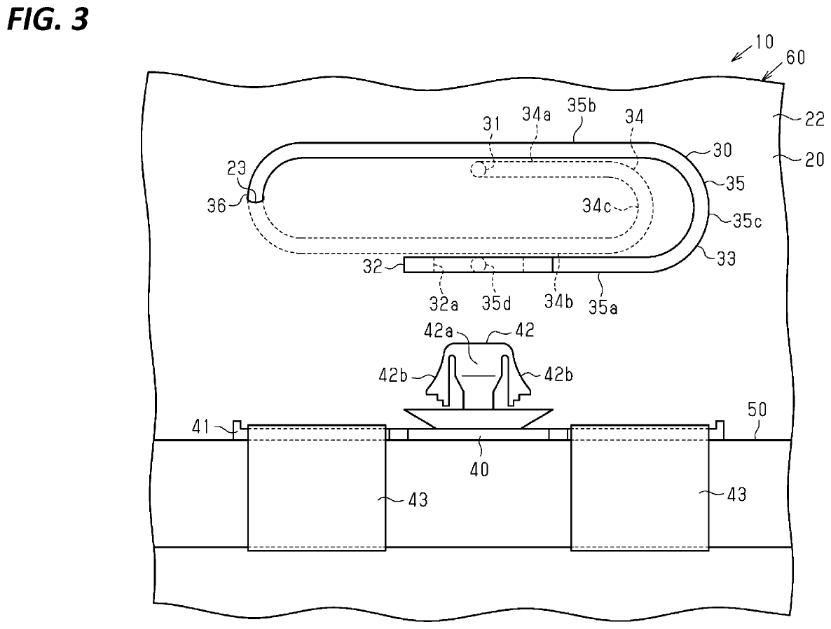

Specifically, as shown in FIGS. 2 and 3, the clip portion 33 is formed by bending a metal wire member, and has an oval shape overall when viewed in a first direction orthogonal to the sheet 20. Note that the “oval shape” used herein includes not only an oval shape having strictly parallel parts and strictly arc parts, but also a substantially oval shape within a range where functional effects of this embodiment are exhibited.

The clip portion 33 includes a first constituent part 34 located on the first main face 21 side, a second constituent part 35 located on the second main face 22 side, and an intermediate connection part 36 that connects the first constituent part 34 and the second constituent part 35 to each other and is located to pass through the sheet 20.

The first constituent part 34 includes a pair of first parallel longitudinally extending parts 34a and 34b, and a first connection part 34c that connects the first longitudinally extending parts 34a and 34b to each other. The first longitudinally extending part 34a that is continuous with the leading end penetrating portion 31 is set such that the length from the first connection part 34c is the length to the center in the longitudinal direction of the clip portion 33. That is, the leading end penetrating portion 31 is arranged at the center in the longitudinal direction of the clip portion 33. In other words, the length from the leading end penetrating portion 31 to one end portion of the clip portion 33 in the longitudinal direction is the same as the length from the leading end penetrating portion 31 to the other end portion of the clip portion 33 in the longitudinal direction. The leading end penetrating portion 31 is bent at a right angle to extend in the first direction from an end portion of the first longitudinally extending part 34a.

The second constituent part 35 includes a pair of second parallel longitudinally extending parts 35a and 35b, and a second connection part 35c that connects the second longitudinally extending part 35a and 35b to each other. The second longitudinally extending part 35a that is continuous with the fixing portion 32 is set such that the length from the second connection part 35c is the length to the center in the longitudinal direction of the clip portion 33. That is, the fixing portion 32 is arranged at the center in the longitudinal direction of the clip portion 33. In other words, the length from the fixing portion 32 to one end portion of the clip portion 33 in the longitudinal direction is the same as the length from the fixing portion 32 to the other end portion of the clip portion 33 in the longitudinal direction. Also, the fixing portion 32 is arranged at an end portion of the clip portion 33 in the lateral direction. The fixing portion 32 is fixed to a leading end of a fixed end portion 35d bent at a right angle to extend in the first direction from an end portion of the second longitudinally extending part 35a. The fixing portion 32 is joined to the fixed end portion 35d through soldering, welding, or the like. Note that the second constituent part 35 of this embodiment is arranged outward of the first constituent part 34 when viewed in the first direction orthogonal to the sheet 20.

With the clip portion 33, the sheet 20 is held between the first constituent part 34 and the second constituent part 35 in the thickness direction due to the elasticity of the metal wire member that constitutes the clip portion 33.

### [Configuration of Wire Member 50]

The wire member 50 is obtained by collectively covering a wire bundle constituted of a plurality of wires with an outer cover member such as tape, for example.

### [Configuration of Fixing Member 40]

The fixing member 40 is made of a resin.

The fixing member 40 is fixed to the wire member 50, and is fitted to the fixing portion 32. Specifically, the fixing member 40 includes a wire fixing portion 41 fixed to the wire member 50, and a fitting portion 42 that protrudes from the wire fixing portion 41, passes through the fixing hole 32a, and is fitted to the fixing portion 32. The wire fixing portion 41 of this embodiment has a rectangular plate shape, and is fixed to the wire member 50 by winding the tape 43 around the wire fixing portion 41 together with the wire member 50 along the wire member 50. The fitting portion 42 of this embodiment has a base portion 42a that protrudes from the wire fixing portion 41, and flexible pieces 42b that respectively extend from both sides of the leading end of the base portion 42a to the base end side and have flexibility in the width direction. The fitting portion 42 is capable of passing through the fixing hole 32a through movement of the flexible pieces 42b inward in the width direction. Once the fitting portion 42 has passed through the fixing hole 32a, the flexible pieces 42b move outward in the width direction, the fitting portion 42 is fitted to the fixing portion 32, thus preventing the fitting portion 42 from coming off from the fixing hole 32a.

Effects of the cable routing module 10 configured as described above will be described below.

The mounting member 30 is mounted on the sheet 20 from the second main face 22 side. Specifically, the mounting member 30 is first pushed from the second main face 22 side such that the leading end penetrating portion 31 comes through the sheet 20, and the first constituent part 34 is operated to pass through the through-hole 23 formed in the sheet 20 and mounted on the sheet 20. The mounting member 30 is held by the sheet 20 as a result of the sheet 20 being held between the first constituent part 34 and the second constituent part 35 of the clip portion 33 in the thickness direction due to the elasticity thereof.

With the fixing member 40, the fitting portion 42 is fitted to the fixing portion 32 of the mounting member 30 (see FIG. 2) in a state in which the wire fixing portion 41 is fixed to the wire member 50 (see FIG. 3).

In the cable routing module 10 assembled in this manner, the wire member 50 is routed with respect to the sheet 20 such that the position of the wire member 50 does not shift from a preset position.

Next, effects of the above embodiment will be described below.

(1) The clip portion 33 that holds the sheet 20 in the thickness direction can prevent the mounting member 30 from coming off from the sheet 20. Further, because the leading end penetrating portion 31 capable of penetrating a portion of the sheet 20 from the second main face 22 side to the first main face 21 side eliminates the need to provide a mounting hole in the sheet 20 in advance, and enables the mounting member 30 to be mounted on the portion of the sheet 20. Therefore, the wire member 50 can be fixed to the mounting member 30 by arranging the sheet 20 on the inner surface of the ceiling of a vehicle body and freely mounting the mounting member 30 on a portion, for example.

(2) The holding portion that holds the sheet 20 in the thickness direction is the clip portion 33 constituted of a wire member and having an oval shape overall, and thus can favorably hold the sheet 20 with a simple structure.

(3) Because the fixing portion 32 is located at the center in the longitudinal direction of the clip portion 33, the fixing portion 32 is supported by the clip portion 33 in a well-balanced manner, compared to a case where the fixing portion 32 is arranged at a position shifted from the center in the longitudinal direction of the clip portion 33, for example.

(4) Because the leading end penetrating portion 31 extends in the first direction orthogonal to the sheet 20 in a state in which the mounting member 30 is mounted on the sheet 20, it is possible to easily perform operation of passing the leading end penetrating portion 31 through the sheet 20 from the second main face 22 side to the first main face 21.

(5) Because the clip portion 33 and the fixing portion 32 are made of a metal, separately shaped portions can be easily joined together. Thus, the mounting member 30 can be easily produced.

(6) The mounting unit 70 includes the mounting member 30, and the fixing member 40 fixed to the wire member 50 and fitted to the fixing portion 32. Therefore, by fixing the fixing member 40 to the wire member 50 and fitting the fixing member 40 to the fixing portion 32, the wire member 50 can be easily mounted on the mounting member 30.

(7) Because the fixing member 40 includes the wire fixing portion 41 fixed to the wire member 50, and the fitting portion 42 that protrudes from the wire fixing portion 41, passes through the fixing hole 32a of the fixing portion 32, and is fitted to the fixing portion 32, the wire member 50 can be easily attached to the mounting member 30.

### Modification Examples

This embodiment can be modified and implemented as follows. This embodiment and the following modification examples may be combined and implemented to the extent that they do not contradict each other technically.
Although the fixing portion 32 is arranged at an end portion of the clip portion 33 in the lateral direction in the above embodiment, the present invention is not limited to this. A configuration may be adopted in which the fixing portion 32 is arranged at another position of the clip portion 33 in the lateral direction.

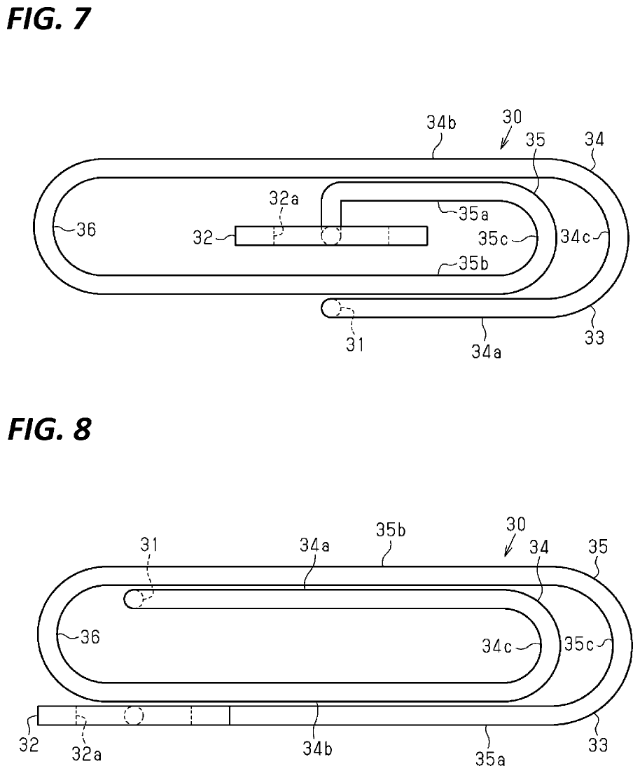

As shown in FIG. 7, a configuration may be adopted in which the fixing portion 32 is arranged at the center in the lateral direction of the clip portion 33. In other words, a configuration may be adopted in which the length from the fixing portion 32 to one end portion of the clip portion 33 in the lateral direction is the same as the length from the fixing portion 32 to the other end portion of the clip portion 33 in the lateral direction.

Note that the second constituent part 35 in this example is arranged inward of the first constituent part 34 when viewed in the first direction orthogonal to the sheet 20, and the second longitudinally extending part 35a that is continuous with the fixing portion 32 is bent toward the center in the lateral direction of the clip portion 33.

With this configuration, the fixing portion 32 is supported by the clip portion 33 in a well-balanced manner, compared to a case where the fixing portion 32 is arranged at a position shifted from the center in the lateral direction of the clip portion 33, for example.
Although the first longitudinally extending part 34a that is continuous with the leading end penetrating portion 31 is set such that the length from the first connection part 34c is the length to the center in the longitudinal direction of the clip portion 33 in the above embodiment, the length of the first longitudinally extending part 34a may be changed.

As shown in FIG. 8, for example, the length, from the first connection part 34c, of one first longitudinally extending part 34a that is continuous with the leading end penetrating portion 31 may be set such that the first longitudinally extending part 34a extends beyond the center in the longitudinal direction of the clip portion 33.

With this configuration, the clip portion 33 can hold the sheet 20 in a longer range and more strongly hold the sheet 20, compared to a case where the length, from the first connection part 34c, of one first longitudinally extending part 34a is set to the length to the center in the longitudinal direction of the clip portion 33, for example.

Although the length, from the second connection part 35c, of the second longitudinally extending part 35a that is continuous with the fixing portion 32 is set to the length to the center in the longitudinal direction of the clip portion 33 in the above embodiment, the length of the second longitudinally extending part 35a may be changed.

As shown in FIG. 8, for example, the length, from the second connection part 35c, of one second longitudinally extending part 35a that is continuous with the fixing portion 32 may be set such that the second longitudinally extending part 35a extends beyond the center in the longitudinal direction of the clip portion 33.

With this configuration, the clip portion 33 can hold the sheet 20 in a longer range and more strongly hold the sheet 20, compared to a case where the length, from the second connection part 35c, of the second longitudinally extending parts 35a is set to the length to the center in the longitudinal direction of the clip portion 33, for example.
Although the leading end penetrating portion 31 extends in the first direction orthogonal to the sheet 20 in a state in which the mounting member 30 is mounted on the sheet 20 in the above embodiment, the present invention is not limited to this. A configuration may be adopted in which the leading end penetrating portion 31 extends in another direction.

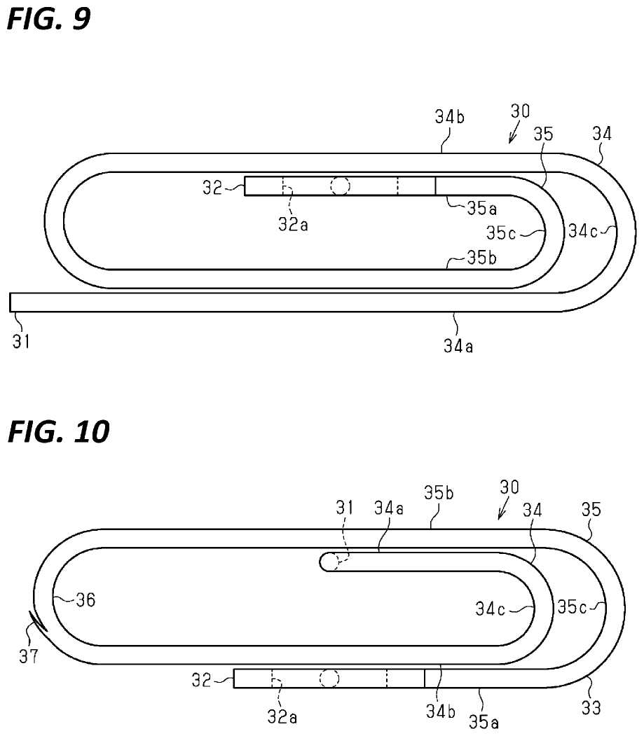

As shown in FIG. 9, a configuration may be adopted in which the leading end penetrating portion 31 extends from the first longitudinally extending part 34a without being bent, for example. In other words, a configuration may be adopted in which the leading end penetrating portion 31 extends along the first main face 21 of the sheet 20 in a state in which the mounting member 30 is mounted on the sheet 20.

Note that the first constituent part 34 in this example is arranged outward of the second constituent part 35 when viewed in the first direction orthogonal to the sheet 20, and the leading end penetrating portion 31 extends from the first longitudinally extending part 34a without being bent and protrudes in the longitudinal direction of the clip portion 33.

With this configuration, the leading end penetrating portion 31 does not protrude greatly from the first main face 21, and there is no need to provide a large mounting space on the first main face 21 side. That is, this configuration can also handle a case where there is not much depth on the first main face 21 side.
The mounting member 30 of the above embodiment may be configured to have a coming-off preventing portion that engages with the sheet 20 and prevents the clip portion 33 from coming off from the first main face 21 side to the second main face 22.

As shown in FIG. 10, for example, the mounting member 30 may be configured to have a claw portion 37 serving as a coming-off preventing portion that engages with the sheet 20 and prevents the clip portion 33 from coming off from the first main face 21 side to the second main face 22. The claw portion 37 is provided in the intermediate connection part 36. The claw portion 37 prevents the first constituent part 34 from coming loose from the through-hole 23 as a result of the claw portion 37 being caught on the sheet 20 in a state in which the mounting member 30 is mounted on the sheet 20.

With this configuration, the claw portion 37 prevents the clip portion 33 from coming off from the first main face 21 side to the second main face 22 side. Therefore, it is possible to prevent the wire member 50 from coming off from the sheet 20 together with the mounting member 30.
The mounting member 30 of the above embodiment may be configured to have a rotation prevention portion that engages with the sheet 20 and prevents the clip portion 33 from rotating with respect to the sheet 20.

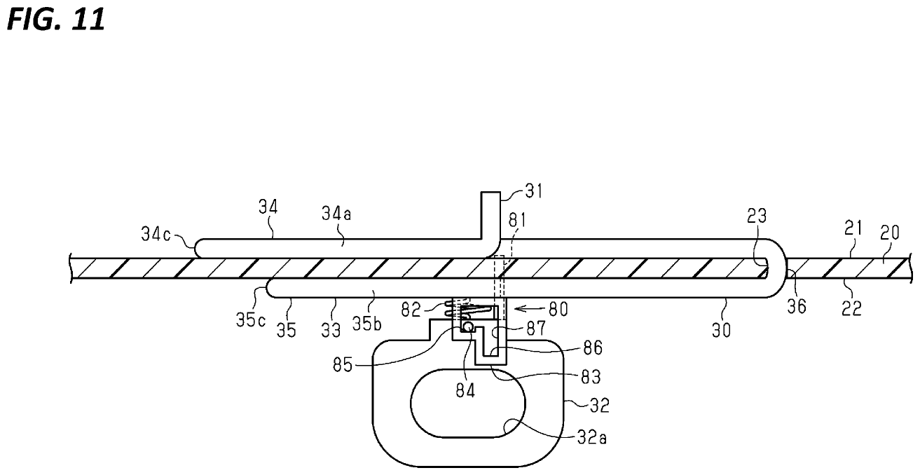

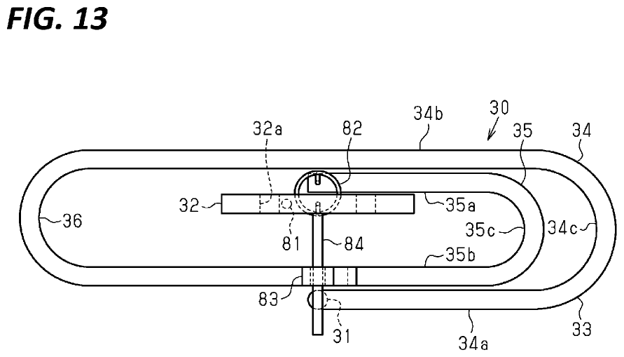

As shown in FIGS. 11 to 13, for example, the mounting member 30 may be configured to have a rotation prevention portion 80, for example. The rotation prevention portion 80 includes a rotation prevention penetrating portion 81, a coil spring 82 serving as a biasing portion, and a maintaining portion 83.

The rotation prevention penetrating portion 81 is provided extending from the fixing portion 32 in a rod shape, and is capable of penetrating a portion of the sheet 20 from the second main face 22 side to the first main face 21 side. The coil spring 82 is connected to connect the second longitudinally extending part 35a of the clip portion 33 to the fixing portion 32, and biases the rotation prevention penetrating portion 81 in a direction away from the second main face 22 together with the fixing portion 32.

The maintaining portion 83 is provided on the second longitudinally extending part 35b that is not continuous with the fixing portion 32, and maintains a state in which the rotation prevention penetration portion 81 penetrates the sheet 20 against the biasing force of the coil spring 82. Specifically, first, the fixing portion 32 includes a locking rod 84 that extends in a direction orthogonal to the rotation prevention penetrating portion 81. The maintaining portion 83 includes a guide part 87 that guides the locking rod 84 movably between a first position 85 and a second position 86, and is configured to be capable of locking the locking rod 84 at the first position 85 and the second position 86. The first position 85 and the second position 86 are shifted in the longitudinal direction of the clip portion 33, and a step is provided therebetween. The locking rod 84 is locked at the first position 85 and the second position 86 in a state in which the locking rod 84 is pressed by the biasing force of the coil spring 82 and is in contact with the coil spring 82.

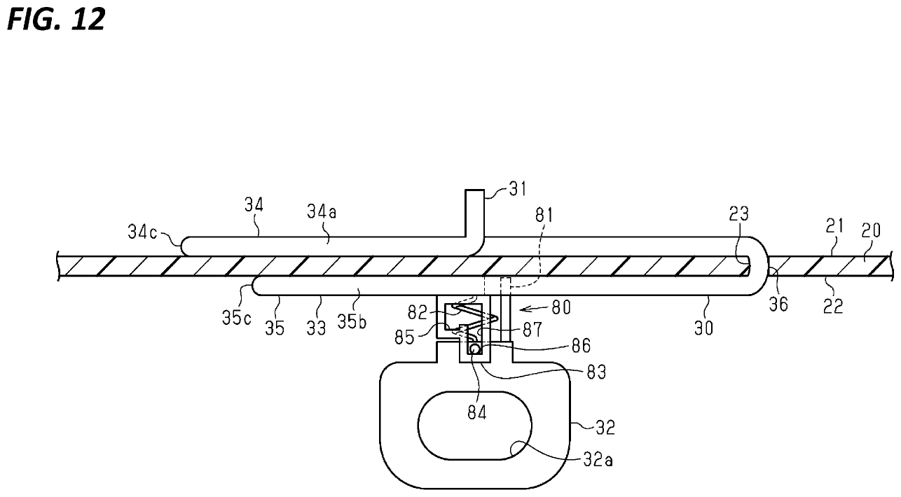

As shown in FIG. 11, the first position 85 is set to a position where the state in which the rotation prevention penetrating portion 81 penetrates the sheet 20 is maintained. As shown in FIG. 12, the second position 86 is set to a position where the rotation prevention penetrating portion 81 is kept separated from the second main face 22 of the sheet 20. That is, as shown in FIG. 11, in the state in which the locking rod 84 is locked at the first position 85, the state in which the rotation prevention penetrating portion 81 penetrates the sheet 20 is maintained. Also, as shown in FIG. 12, in the state in which the locking rod 84 is locked at the second position 86, the rotation prevention penetrating portion 81 is kept separated from the second main face 22 of the sheet 20.

The mounting member 30 having such a configuration is first mounted on the sheet 20 from the second main face 22 side in a manner similar to that of the above embodiment in a state in which the locking rod 84 is locked at the second position 86. Specifically, the mounting member 30 is first pushed from the second main face 22 side such that the leading end penetrating portion 31 comes through the sheet 20, and the first constituent part 34 is operated to pass through the through-hole 23 formed in the sheet 20 and mounted on the sheet 20. As shown in FIG. 12, the mounting member 30 is held by the sheet 20 as a result of the sheet 20 being held between the first constituent part 34 and the second constituent part 35 of the clip portion 33 in the thickness direction due to the elasticity thereof.

Further, as shown in FIG. 11, the mounting member 30 is assembled by operating the fixing portion 32 such that the rotation prevention penetrating portion 81 is pushed to come through the sheet 20, and the locking rod 84 is locked at the first position 85.

In this example, as shown in FIG. 12, in the state in which the locking rod 84 is locked at the second position 86, the rotation prevention penetrating portion 81 becomes separated from the second main face 22 due to the action of the coil spring 82. Therefore, restriction of movement of the clip portion 33 as a result of the rotation prevention penetrating portion 81 passing through the sheet 20 when the clip portion 33 is arranged on the sheet 20 is avoided. Also, as shown in FIG. 11, in the state in which the locking rod 84 is locked at the first position 85, the state in which the rotation prevention penetrating portion 81 penetrates the sheet 20 is maintained. Therefore, rotation of the clip portion 33 with respect to the sheet 20 is prevented by two portions, namely, the intermediate connection part 36 that passes through the through-hole 23 of the sheet 20 and the rotation prevention penetrating portion 81. As a result, it is possible to prevent the wire member 50 from rotating with respect to the sheet 20 together with the mounting member 30.

Note that, although the coil spring 82 is used as a biasing portion in this example, the shape or configuration of the biasing portion may be modified as long as the biasing portion functions in a similar manner. The biasing portion may be configured utilizing the elasticity of a metal wire member that constitutes the clip portion 33, for example. That is, the clip portion 33 and the biasing portion may be constituted of a continuous metal wire member.
Although not specifically mentioned in the above embodiment, the leading end of the leading end penetrating portion 31 may be a leading end obtained by simply cutting a metal wire member or may be processed to become finer toward the leading end as long as the leading end need only be capable of penetrating a portion of the sheet 20 provided with no hole.
Although the holding portion that holds the sheet 20 in the thickness direction is the clip portion 33 constituted of a wire member and having an oval shape overall in the above embodiment, the holding portion may be modified to have another configuration as long as the holding portion can hold the sheet 20 in the thickness direction. The holding portion may be a clip portion constituted of a wire member and having a circular shape overall, for example.
Although the fixing portion 32 is made of a metal in the above embodiment, the present invention is not limited to this. The fixing portion 32 may be made of a resin.
Although the wire member 50 is configured to be fixed to the fixing portion 32 of the mounting member 30 via the fixing member 40 in the above embodiment, the present invention is not limited to this. A configuration may be adopted in which the wire member 50 is directly fixed to the fixing portion 32, for example. A configuration may be adopted in which the wire member 50 passes through the fixing hole 32a and thus is fixed to the fixing portion 32.
Although the configuration in which the wire fixing portion 41 of the fixing member 40 is fixed to the wire member 50 by winding the tape 43 around the wire fixing portion 41 together with the wire member 50 in the above embodiment, the present invention is not limited to this. The wire fixing portion having a belt that is wound around and fixed to the wire member 50 may be used, for example.
Although the fixing portion 32 is plate-shaped in the above embodiment, the present invention is not limited to this. The shape of the fixing portion 32 may be changed to a rod shape or the like, for example. Also, the shape of the fixing portion 32 may be changed to another shape, and the fixing portion 32 may be constituted of a continuous metal wire member that constitutes the leading end penetrating portion 31 and the clip portion 33.
Although a harness component fixed to the mounting member 30 is assumed to be the wire member 50 in the above embodiment, the present invention is not limited to this. Other harness components such as a connector or a protector may be used, for example.
Although the sheet 20 is, for example, a roof lining provided on the inner surface of the ceiling of a vehicle body in the above embodiment, the present invention is not limited to this. The sheet 20 may be a sheet provided at another part such as a door trim, for example.
Although the sheet 20 is made of a nonwoven fabric in the above embodiment, the present invention is not limited to this. The sheet 20 may be other sheets such as knitted fabric or felt.

The mounting member 30 of the above embodiment may be referred to as a jig used to position and mount the wire member 50 on the sheet 20. The wire member 50 of the above embodiment may be referred to as a vehicle electric cable. The sheet 20 of the above embodiment may be referred to as a flexible vehicle sheet. The fixing portion 32 of the mounting member 30 of the above embodiment may be referred to as a tab, which may be a flat plate. The fixing hole 32a of the fixing portion 32 may be referred to as a tab hole, which may be a through-hole. The leading end penetrating portion 31 and the clip portion 33 of the mounting member 30 of the above embodiment may be referred to as wire members having a leading end, a base end, and a linear intermediate portion that extends between the leading end and the base end and includes a spiral portion or a winding portion. The wire fixing portion 41 of the fixing member 40 of the above embodiment may be referred to as a cable fixing plate configured including a contact surface that is in contact with the outer circumferential surface of the wire member 50 and a non-contact surface opposite to the contact surface, the cable fixing plate being configured to be fixedly mounted on the outer circumferential surface of the wire member 50. The fitting portion 42 of the fixing member 40 of the above embodiment may be referred to as a protrusion that protrudes from the non-contact surface of the cable fixing plate.
An embodiment of this disclosure is directed to a jig (30) used to position and mount a vehicle electric cable (50) on a vehicle flexible sheet (20), the jig (30) including:
a wire member (33) having a leading end, a base end, and a linear intermediate portion that extends between the leading end and the base end and includes a spiral portion or a winding portion; and
a tab (32) that is connected to the base end of the wire member (33) and cantilevers the wire member (33).
According to an embodiment of this disclosure, the tab (32) may be a flat plate having a through-hole (32a).
According to an embodiment of this disclosure, the tab (32) may be a metal plate member.
According to an embodiment of this disclosure, the wire member (33) may be a metal wire member.
The jig (30) according to several embodiments of this disclosure may be used together with
a cable side fixing member (40) provided with a cable fixing plate (41) having a contact surface that is in contact with an outer circumferential surface of a vehicle electric cable (50) and a non-contact surface opposite to the contact surface, the cable fixing plate (41) being configured to be fixedly mounted on the outer circumferential surface of the vehicle electric cable (50), and
a protrusion (42) protruding from the non-contact surface of the cable fixing plate (41), and
the jig (30) may be configured to indirectly support the vehicle electric cable (50) via the cable side fixing member (40).
In several embodiments of this disclosure, the mounting member (30) is to be mounted on the sheet (20) having a first main face (21) and a second main face (22) provided on the back side of the first main face (21), and the harness component (50) is to be fixed to the mounting member (30), and the mounting member (30) may include:
a leading end penetrating portion (31) that forms the through-hole portion (23) in the sheet (20) by penetrating the sheet (20) from the second main face (22) side to the first main face (21) side;
a fixing portion (32) that is located on the second main face (22) side and to which the harness component (50) is to be fixed; and
a holding portion (33) that connects the leading end penetrating portion (31) and the fixing portion (32) to each other, and holds the sheet (20) in a thickness direction,
the holding portion (33) may include:
a first constituent part (34) that passes through the through-hole (23) from the second main face (22) side and is positioned on the first main face (21) side;
a second constituent part (35) that is positioned on the second main face (22) side without passing through the through-hole (23); and
an intermediate connection part (36) that connects the first constituent part (34) and the second constituent part (35) to each other,
the first constituent part (34) and the second constituent part (35) may hold the sheet (20) in the thickness direction respectively from the first main face (21) side and the second main face (22) side, and
the intermediate connection part (36) may pass through the through-hole (23) (the sheet (20)) in a state in which the sheet (20) is sandwiched in the thickness direction between the first constituent part (34) and the second constituent part (35).

### LIST OF REFERENCE NUMERALS

10 Cable routing module
20 Sheet
21 First main face
22 Second main face
23 Through-hole
30 Mounting member
31 Leading end penetrating portion
32 Fixing portion
32a Fixing hole
33 Clip portion (holding portion)
34 First constituent part
34a First longitudinally extending part
34b First longitudinally extending part
34c First connection part
35 Second constituent part
35a Second longitudinally extending part
35b Second longitudinally extending part
35c Second connection part
35d Fixed end portion
36 Intermediate connection part
37 Claw portion (coming-off preventing portion)
40 Fixing member
41 Wire fixing portion
42 Fitting portion
42a Base portion
42b Flexible piece
43 Tape
50 Wire member (harness component)
60 Cable routing member
70 Mounting unit
80 Rotation prevention portion
81 Rotation prevention penetrating portion
82 Coil spring (biasing portion)
83 Maintaining portion
84 Locking rod
85 First position
86 Second position
87 Guide part

1. A mounting member that is to be mounted on a sheet having a first main face and a second main face provided on the back side of the first main face, and to which a harness component is to be fixed, the mounting member comprising:
a leading end penetrating portion that is located on the first main face side and is capable of penetrating a portion of the sheet from the second main face side to the first main face side;
a fixing portion that is located on the second main face side and to which the harness component is to be fixed; and
a holding portion that connects the leading end penetrating portion and the fixing portion to each other, and holds the sheet in a thickness direction.

2. The mounting member according to claim 1,
wherein the holding portion is a clip portion constituted of a wire member and having an oval shape overall when viewed in a first direction orthogonal to the sheet.

3. The mounting member according to claim 2,
wherein the fixing portion is located at a center in a longitudinal direction of the clip portion.

4. The mounting member according to claim 2,
wherein the fixing portion is located at a center in a lateral direction of the clip portion.

5. The mounting member according to claim 2,
wherein the clip portion includes a first constituent part located on the first main face side, a second constituent part located on the second main face side, and an intermediate connection part that connects the first constituent part and the second constituent part to each other and is located to pass through the sheet,
the first constituent part includes a pair of first parallel longitudinally extending parts, and a first connection part that connects the first longitudinally extending parts to each other,
the second constituent part includes a pair of second parallel longitudinally extending parts, and a second connection part that connects the second longitudinally extending parts to each other, and
the length, from the first connection part, of one of the first longitudinally extending parts that is continuous with the leading end penetrating portion is set such that the one first longitudinally extending part extends beyond a center in a longitudinal direction of the clip portion.

6. The mounting member according to claim 2,
wherein the clip portion includes a first constituent part located on the first main face side, a second constituent part located on the second main face side, and an intermediate connection part that connects the first constituent part and the second constituent part to each other and is located to pass through the sheet,
the first constituent part includes a pair of first parallel longitudinally extending parts, and a first connection part that connects the first longitudinally extending parts to each other,
the second constituent part includes a pair of second parallel longitudinally extending parts, and a second connection part that connects the second longitudinally extending parts to each other, and
the length, from the second connection part, of one of the second longitudinally extending parts that is continuous with the fixing portion is set such that the one second longitudinally extending part extends beyond a center in a longitudinal direction of the clip portion.

7. The mounting member according to claim 2,
wherein the leading end penetrating portion extends in the first direction.

8. The mounting member according to claim 2,
wherein the leading end penetrating portion extends along the first main face.

9. The mounting member according to claim 1, further comprising
a come-off preventing portion that prevents the holding portion from coming off from the first main face side to the second main face side through engagement with the sheet.

10. The mounting member according to claim 1, further comprising
a rotation prevention portion that prevents rotation of the holding portion with respect to the sheet through engagement with the sheet.

11. The mounting member according to claim 10,
wherein the rotation prevention portion includes
a rotation prevention penetrating portion capable of penetrating a portion of the sheet from the second main face side to the first main face side,
a biasing portion that biases the rotation prevention penetrating portion in a direction away from the second main face, and
a maintaining portion that maintains a state in which the rotation prevention penetrating portion penetrates the sheet against a biasing force of the biasing portion.

12. The mounting member according to claim 1,
wherein the holding portion and the fixing portion are made of a metal.

13. A mounting unit comprising:
the mounting member according to claim 1; and
a fixing member that is fixed to the harness component and fitted to the fixing portion.

14. The mounting unit according to claim 13,
wherein the fixing portion has a fixing hole,
the harness component is a wire member, and
the fixing member has a wire fixing portion that is fixed to the wire member and a fitting portion that protrudes from the wire fixing portion, passes through the fixing hole, and is fitted to the fixing portion.

15. A cable routing module comprising:
the mounting unit according to claim 13;
the harness component to which the fixing member is fixed; and
the sheet on which the mounting member is mounted.

16. A cable routing member comprising:
the mounting member according to claim 1; and
the sheet on which the mounting member is mounted.
